(19) United States
(12) Patent Application Publication
(10) Pub. No.: US 2026/0016864 A1
(43) Pub. Date: Jan. 15, 2026

(54) WATERDROP-TYPE HINGE MODULE FOR FOLDABLE PORTABLE TERMINAL AND FOLDABLE PORTABLE TERMINAL USING THE SAME

(71) Applicant: PARTSTEC CONSTRUCTION CO., LTD, Gumi-Si, Gyeongsangbuk-Do (KR)

(72) Inventors: Young Tak Lee, Gumi-Si, Gyeongsangbuk-Do (KR); Kil Seok Jeong, Gumi-Si, Gyeongsangbuk-Do (KR)

(21) Appl. No.: 18/994,603

(22) PCT Filed: May 21, 2024
(86) PCT No.: PCT/KR2024/006836

§ 371 Date: Jan. 14, 2025

(30) Foreign Application Priority Data
May 23, 2023 (KR) 10-2023-0066573

(51) Int. Cl. G06F 1/16

(52) U.S. Cl. CPC G06F 1/1681; G06F 1/1652

(57) ABSTRACT

The present invention relates to a waterdrop-type hinge module for a foldable portable terminal and a foldable portable terminal using the same, particularly, to a waterdrop-type hinge module for a foldable portable terminal that curbs damage to a flexible display by forming a folding part of the flexible display into a waterdrop shape when the unfolded foldable portable terminal is folded, and a foldable portable terminal using the same.

### TECHNICAL FIELD

The present invention relates to a waterdrop-type hinge module for a foldable portable terminal and a foldable portable terminal using the same, particularly, to a waterdrop-type hinge module for a foldable portable terminal that curbs damage to a flexible display by forming a folding part of the flexible display into a waterdrop shape when the unfolded foldable portable terminal is folded, and a foldable portable terminal using the same.

### BACKGROUND ART

In general, flexible display panels are display panels that can be bent with a given curvature.

Since these flexible display panels include plastic substrates instead of the commonly used glass substrates, the flexible display panels are often manufactured using a low-temperature manufacturing process instead of the existing manufacturing processes in order to curb damage to the substrates.

These flexible display panels are manufactured as touchscreens which can receive user commands in a touch manner, for example, on which capacitive or resistive touch input can be performed.

Meanwhile, portable foldable display devices, that is, folding-type portable terminals, in the related art are equipped with a flexible display panel on which touch input can be performed as described above.

The folding-type portable terminals in the related art described above have, at a part where the hinge connection is performed between a pair of bodies supporting a flexible display panel, a given accommodating space enabling a folded part of the flexible display panel to be bent in a curved shape.

Various hinge modules are currently developed to be used for opening and closing the flexible displays described above.

However, most hinge modules have a complex structure, a large number of components, and a significant thickness at a folding part, and have a risk of damage due to infiltration of foreign matter into and impact on a large gap produced at a part of the flexible display that is folded and facing when the flexible display is folded.

In particular, a folding central part of the flexible display needs to form a waterdrop shape having a narrow top and a wide bottom in order to prevent damage and concentration of a load when being folded. However, the hinge modules in the related art have limitations in perfectly implementing this shape.

### SUMMARY OF INVENTION

### Technical Problem

The present invention is made to solve the above-described problems, and an object thereof is to provide a waterdrop-type hinge module for a foldable portable terminal that enables a folding center of a flexible display to be folded while stably forming a waterdrop shape when the foldable portable terminal is folded by using a relatively simple structure and a small number of components, and a foldable portable terminal using the same.

### Solution to Problem

In order to achieve the object, provided is a waterdrop-type hinge module for a foldable portable terminal, including: a base body; a pair of first levers that are disposed separately from each other on both sides of the base body, each having one end coupled to the base body to be rotatable in a vertical direction; a lever link that connects the pair of first levers separated from each other to synchronize rotational motion of the pair of first levers; swing plates that are fixedly coupled to the other ends of the first levers and form a folding part of a flexible display mounted on the portable terminal into a waterdrop shape having a narrow top and a wide bottom when the portable terminal is closed; slide levers having one ends coupled to the base body to be rotatable in the vertical direction; and slide blocks that have respective upper ends which are rotatably hinge-coupled to the swing plates and respective lower ends to which the slide levers are slidably coupled. When the portable terminal is closed, one of the first levers and one of the swing plates are rotated together, the slide blocks are pulled out from the slide levers and slide while being rotated together with the swing plates, and the slide levers are rotated with respect to the base body by the rotation of the slide blocks.

When the portable terminal is closed, one of the first levers and one of the swing plates are rotated beyond 90 degrees from a horizontal state, and the slide levers and slide blocks are rotated at an angle smaller than that of the first levers and the swing plates, as the slide levers are in contact with respective stop bumps formed on the base body and stop rotating.

Outer circumferential surfaces of the one ends of the first levers have respective cam grooves which are obliquely formed, both ends of the lever link are disposed to be inserted into the cam grooves of the first levers which are disposed on both sides, and the pair of first levers are rotated in a direction in which the first levers come closer to each other or move away from each other as one of the first levers is rotated and then the other first lever is also synchronized to rotate by the cam groove and the lever link.

The one ends of the first levers are formed in a semicircular shape, and the cam grooves are formed along the respective outer circumferential surfaces of the one ends of the first levers which are formed in the semicircular shape.

When the pair of first levers are horizontally unfolded in opposite directions, the cam grooves formed in the pair of first levers are obliquely formed in the same direction, the lever link is disposed to be rotatable from the base body in a horizontal direction around a vertical axis of the base body, and the pair of first levers are synchronized to rotate by horizontal rotation of the lever link.

The base body includes an upper body and a lower body which are layered on each other to be coupled, the one ends of the first levers and one ends of the lever link and the slide levers are inserted and arranged between the upper body and the lower body, the first levers have respective insertion grooves, and the lower body has insertion protrusions formed to be inserted into the insertion grooves, respectively, when the first levers are unfolded in the horizontal direction.

A first rotation center point of one end of the first levers is located above a second rotation center point of one end of the slide levers, and the second rotation center point of the one end of the slide levers is located farther away from a central part of the base body than the first rotation center point of the one end of the first levers is.

The waterdrop-type hinge module for a foldable portable terminal further includes: second levers that have one ends coupled to the base body to be rotatable in the vertical direction and the other ends which are fixedly coupled to the swing plates; and a contact member that is disposed on the base body and is in contact with outer circumferential surfaces of the one ends of the second levers. The contact member applies friction to the outer circumferential surfaces of the one ends of the second levers so that the second levers maintain a stop state at a certain angle when the second levers are rotated.

The second levers form a pair and are disposed to be separated from each other on both sides of the base body, and both ends of the contact member inserted into the base body are in contact respectively with the one ends of the pair of second levers, the second levers being disposed to be separated from each other.

The contact member is formed of a leaf spring having elastic force.

The outer circumferential surfaces of the one ends of the second levers have a first stop groove and a second stop groove which are formed to be separated from each other, both ends of the contact member have respective stop protrusions which are bent to be inserted into the first stop groove or the second stop groove, when the portable terminal is unfolded in a horizontal direction, one of the stop protrusions is inserted into the first stop groove, during a process of folding the portable terminal, the stop protrusions are in contact with the outer circumferential surfaces of the one ends of the second levers between the first stop groove and the second stop groove, and one of the stop protrusions is inserted into the second stop groove when the portable terminal is folded and closed.

When one of the stop protrusions is disposed adjacent to the first stop groove, the stop protrusion is inserted into the first stop groove by the elastic force of the contact member, rotates the second levers, and applies torque in a direction in which the portable terminal is opened. When one of the stop protrusions is disposed adjacent to the second stop groove, the stop protrusion is inserted into the second stop groove by the elastic force of the contact member, rotates the second levers, and applies torque in a direction in which the portable terminal is closed.

The contact member includes main elastic members having the respective stop protrusions bent at both ends of the contact member, and reinforcing members that are layered to be coupled to respective central parts of the main elastic members.

In addition, there is provided a foldable portable terminal of the present invention including: a first body; a second body; a hinge module connecting the first body and the second body, and a flexible display, and the hinge module is configured of the hinge module described above. The first body and the second body are fixedly coupled to the respective slide blocks on both sides, the slide blocks constituting the hinge module.

### Advantageous Effects of Invention

According to the waterdrop-type hinge module for a foldable portable terminal and the foldable portable terminal using the same of the present invention as described above, the following effects will be achieved.

According to the present invention, the folding center of the flexible display can be folded while stably forming a waterdrop shape when the foldable portable terminal is folded.

In particular, the folding center of the flexible display perfectly forms the waterdrop shape so that it is possible to prevent the flexible display from being damaged or subjected to a heavy load while being folded, and it is possible to improve durability.

In addition, a structure of the hinge module is relatively simple and includes a small number of components, and it is possible to improve productivity, assemblability, and workability.

### BRIEF DESCRIPTION OF DRAWINGS

FIG. 1 is a perspective view in one direction illustrating a state in which a hinge module for a foldable portable terminal is unfolded according to an embodiment of the present invention.

FIG. 2 is a perspective view in the other direction illustrating the state in which the hinge module for a foldable portable terminal is unfolded according to the embodiment of the present invention.

FIG. 3 is an exploded perspective view in the one direction illustrating the hinge module for a foldable portable terminal according to the embodiment of the present invention.

FIG. 4 is a perspective view illustrating a state in which an upper body of a base body is removed from FIG. 1.

FIG. 5 is an assembled view of first levers and a lever link according to the embodiment of the present invention.

FIG. 6 is an assembled view of second levers and a contact member according to the embodiment of the present invention.

FIG. 7 is a perspective view illustrating a state in which the hinge module for a foldable portable terminal is rotated by about 45 degrees according to the embodiment of the present invention.

FIG. 8 is a perspective view illustrating a state in which the hinge module for a foldable portable terminal is closed according to the embodiment of the present invention.

FIG. 9 is a side view depicting a process of unfolding the hinge module for a foldable portable terminal according to the embodiment of the present invention.

FIG. 10 is an exploded perspective view of a portable terminal on which the hinge module is mounted according to the embodiment of the present invention.

FIG. 11 is a cross-sectional structure view of the portable terminal on which the hinge module is mounted according to the embodiment of the present invention.

### DESCRIPTION OF EMBODIMENTS

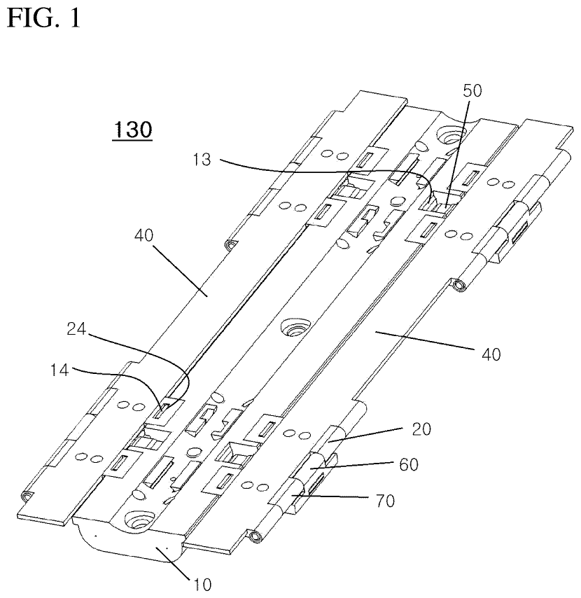

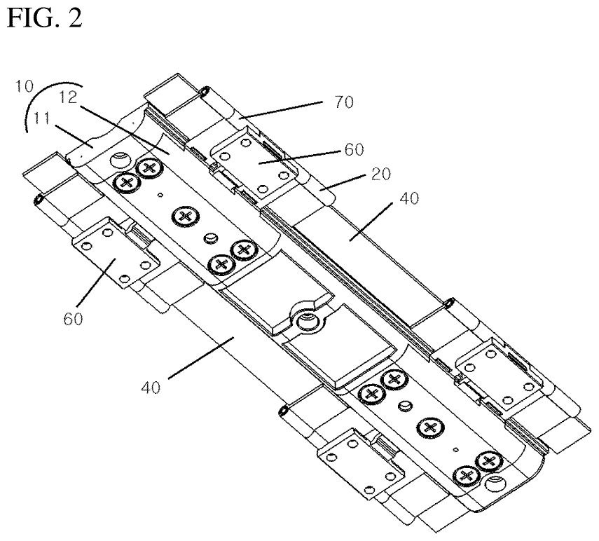

A waterdrop-type hinge module 130 for a foldable portable terminal of the present invention includes, as shown in FIGS. 1 to 4, a base body 10, a first lever 20, a lever link 30, a swing plate 40, a slide lever 50, a slide block 60, and the like.

The base body 10 is formed in a long bar shape.

In this embodiment, the base body 10 includes an upper body 11 and a lower body 12 which are layered on each other to be coupled.

The first levers 20 form a pair and are disposed to be separated from each other on both sides of the base body 10.

One end of the first lever 20 is coupled to the base body 10 to be rotatable in a vertical direction.

Specifically, the one end of the first lever 20 is inserted and disposed between the upper body 11 and the lower body 12.

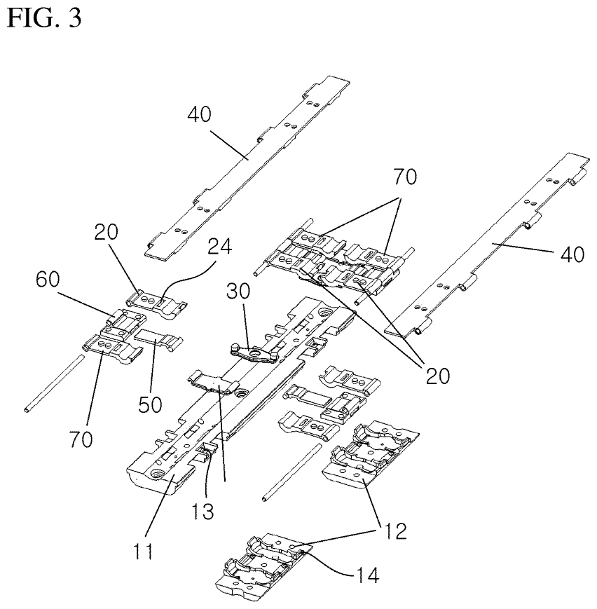

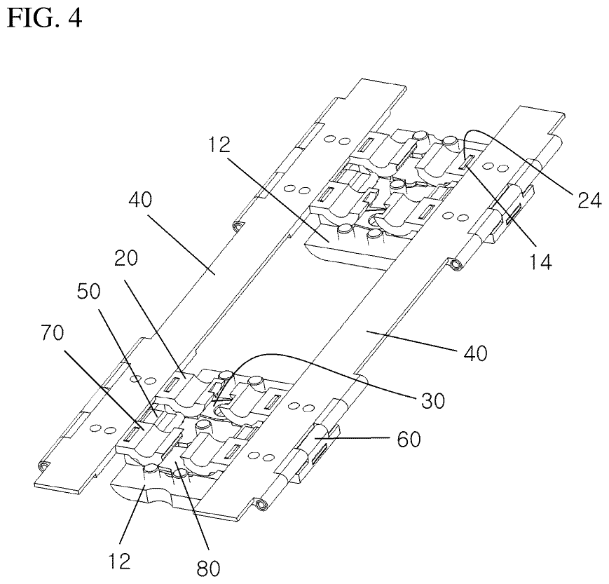

As shown in FIGS. 3 and 4, the first lever 20 has an insertion groove 24, and the lower body 12 has an insertion protrusion 14 that is inserted into the insertion groove 24 when the first lever 20 is unfolded in the horizontal direction.

These insertion grooves 24 and insertion protrusions 14 enable the first levers 20 to maintain an unfolded state in the horizontal direction as is.

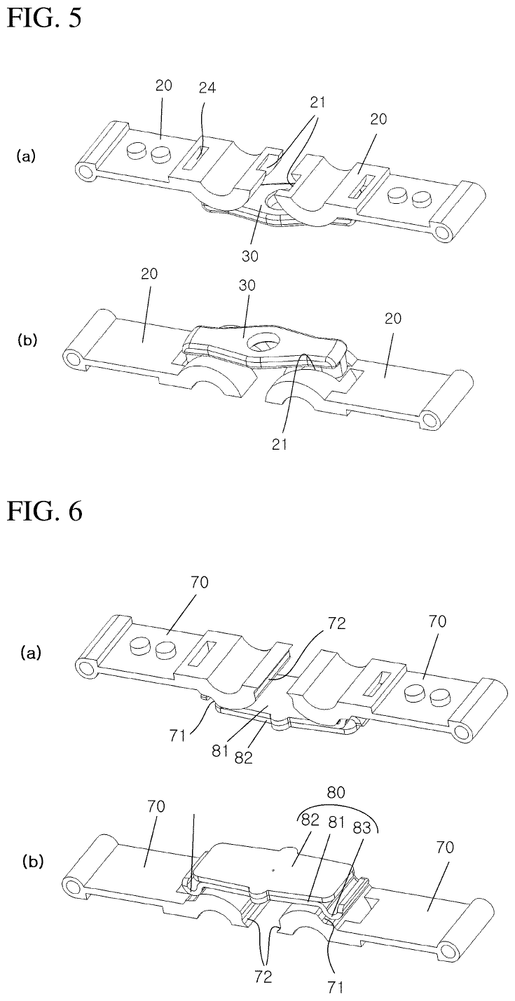

The lever link 30 connects a pair of first levers 20 separated from each other to synchronize rotational motion thereof, as shown in FIGS. 3 to 5.

Specifically, the lever link 30 is inserted and disposed between the upper body 11 and the lower body 12.

Outer circumferential surfaces of one ends of the first levers 20 have respective cam grooves 21 which are obliquely formed, and both ends of the lever link 30 are inserted and disposed in the cam grooves 21 of the first levers 20.

More specifically, the one ends of the first levers 20 are formed in a semicircular shape, and the cam grooves 21 are formed along the respective outer circumferential surfaces of the one ends of the first levers 20 which are formed in the semicircular shape.

When the pair of first levers 20 are horizontally unfolded in opposite directions, the cam grooves 21 formed in the pair of first levers 20 are obliquely formed in the same direction.

Such a structure causes the pair of first levers 20 to be rotated in a direction in which the first levers come closer to each other or move away from each other as one of the first levers 20 is rotated and then the other first lever 20 is also synchronized to rotate by the cam grooves 21 and the lever link 30.

Further, the lever link 30 is disposed to be rotatable in a horizontal direction above the base body 10 around a vertical axis of the base body 10.

The pair of first levers 20 are synchronized to rotate by horizontal rotation of the lever link 30.

The swing plates 40 are fixedly coupled to the other ends of the first levers 20 and are rotated together with the first levers 20 when the first levers are rotated.

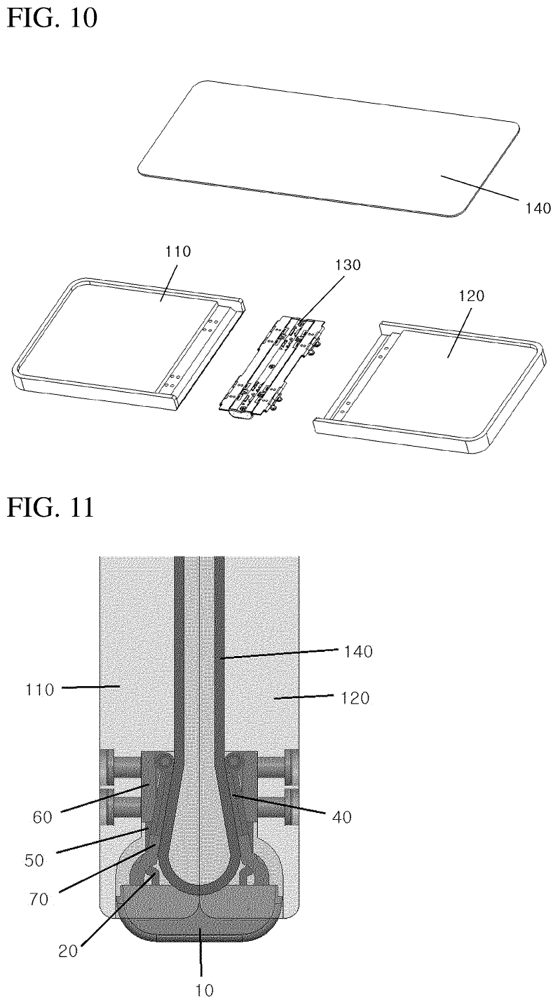

As shown in FIG. 10, a flexible display 140 mounted on a portable terminal is disposed on upper surfaces of the swing plates 40.

As shown in FIG. 11, the swing plates 40 form a folding part of the flexible display 140 mounted on the portable terminal into a waterdrop shape having a narrow top and a wide bottom when the portable terminal is closed.

The slide levers 50 form a pair and are disposed to be separated from each other on both sides of the base body 10.

One ends of these slide levers 50 are coupled to the base body 10 to be rotatable in the vertical direction.

Specifically, the one ends of the slide levers 50 are inserted and disposed between the upper body 11 and the lower body 12.

The slide blocks 60 have respective upper ends which are rotatably hinge-coupled to the swing plates 40 and respective lower ends to which the slide levers 50 are slidably coupled.

A first rotation center point of one end of the first lever 20 is located above a second rotation center point of one end of the slide lever 50.

Further, the second rotation center point of the one end of the slide lever 50 is located farther away from a central part of the base body 10 than the first rotation center point of the one end of the first lever 20 is.

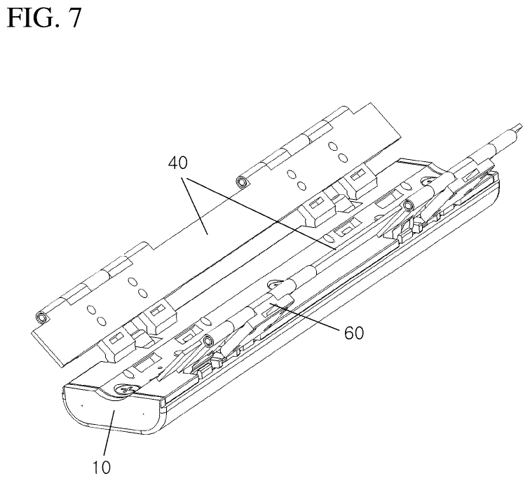

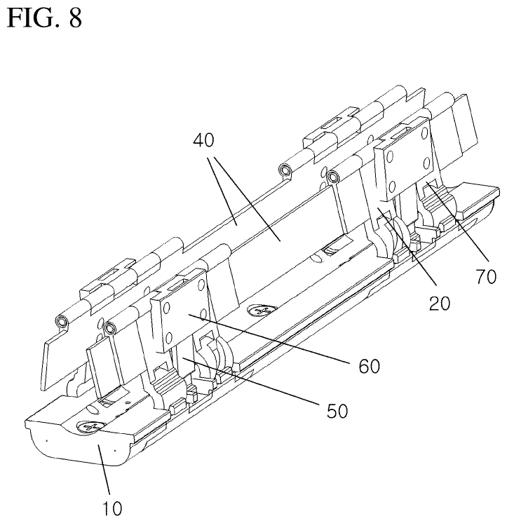

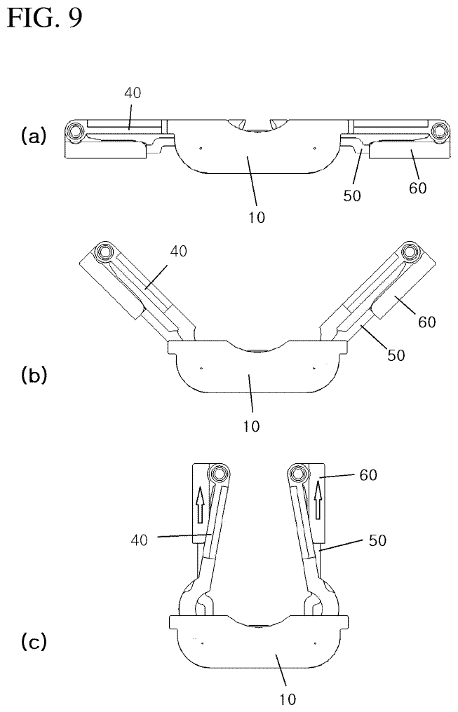

According to the configuration and the structure as described above, when the hinge module and the portable terminal are closed from an unfolded state of the hinge module, that is, when the swing plates 40 on both sides are rotated and moved closer to each other, as shown in FIG. 1 and (a) of FIG. 9, one of the first levers 20 and one of the swing plates 40 are rotated together as illustrated in FIGS. 7 and 8, and (b) and (c) of FIG. 9.

Further, the slide blocks 60 hinge-coupled to the swing plates 40 are pulled out from the slide levers 50 and slide while being rotated together with the swing plates 40 as shown in FIG. 9, and the slide levers 50 are rotated with respect to the base body 10 by the rotation of the slide blocks 60.

When the portable terminal is closed, as shown in FIG. 8 and (c) of FIG. 9, one of the first levers 20 and one of the swing plates 40 are rotated beyond 90 degrees from the horizontal state. When the rotating slide levers 50 are in contact with respective stop bumps 13 formed on the base body 10 and stop rotating, the slide levers 50 and the slide blocks 60 are rotated at an angle smaller than that of the first levers 20 and the swing plates 40.

Preferably, when the portable terminal is closed from the unfolded state, the first levers 20 and the swing plates 40 are to be rotated by 100 degrees, and the slide levers 50 and the slide blocks 60 are to be rotated by 90 degrees.

The present invention can further include second levers 70 and a contact member 80.

One ends of the second levers 70 are coupled to the base body 10, more specifically, are inserted and disposed between the upper body 11 and the lower body 12, to be rotatable in the vertical direction, and the other ends thereof are fixedly coupled to the swing plates 40.

The contact member 80 is disposed in the base body 10, more specifically, between the upper body 11 and the lower body 12.

As shown in FIG. 6, the contact member 80 comes into contact with outer circumferential surfaces of one ends of the second levers 70.

The contact member 80 applies friction to the outer circumferential surfaces of the one ends of the second levers 70 so that the second levers 70 maintain a stop state at a certain angle, that is, implement a free-stop function, when the second levers 70 are rotated.

It is preferable that the second levers 70 form a pair and are disposed to be separated from each other on both sides of the base body 10.

In this case, both ends of the contact member 80 inserted into the base body 10 are in contact respectively with the one ends of the pair of second levers 70, the second levers being disposed to be separated from each other.

Further, the contact member 80 is formed of a leaf spring having elastic force.

The outer circumferential surfaces of the one ends of the second levers 70 have a first stop groove 71 and a second stop groove 72 which are formed to be separated from each other.

Both ends of the contact member 80 have respective stop protrusions 83 which are bent to be inserted into the first stop groove 71 or the second stop groove 72.

When the portable terminal is unfolded in the horizontal direction, one of the stop protrusions 83 is inserted into the first stop groove 71.

During a process of folding the portable terminal, the stop protrusions 83 are in contact with the outer circumferential surfaces of the one ends of the second levers 70 between the first stop groove 71 and the second stop groove 72.

One of the stop protrusions 83 is inserted into the second stop groove 72 when the portable terminal is folded and closed.

According to the configuration described above, when one of the stop protrusions 83 is disposed adjacent to the first stop groove 71, the stop protrusion 83 is inserted into the first stop groove 71 by the elastic force of the contact member 80, rotates the second levers 70, and applies torque in a direction in which the portable terminal is opened.

According to the configuration described above, when one of the stop protrusions 83 is disposed adjacent to the second stop groove 72, the stop protrusion 83 is inserted into the second stop groove 72 by the elastic force of the contact member 80, rotates the second levers 70, and applies torque in a direction in which the portable terminal is closed.

The contact member 80 applying force to the second levers 70 includes a main elastic member 81 and a reinforcing member 82.

The main elastic member 81 is formed by bending the stop protrusions 83 at both ends.

The reinforcing member 82 is layered and coupled to a central part of the main elastic member 81 and increases elasticity of the contact member 80.

Meanwhile, the foldable portable terminal of the present invention includes a first body 110, a second body 120, the hinge module 130 connecting the first body 110 and the second body 120, and the flexible display 140, as shown in FIG. 10.

The hinge module 130 is configured of the hinge module of the present invention described above.

The first body 110 and the second body 120 are fixedly coupled to the respective slide blocks 60 on both sides, the slide blocks constituting the hinge module 130.

While the first body 110 and the second body 120 are rotated in opposite directions and the portable terminal is unfolded, the flexible display 140 is unfolded to be flat.

In this state, when the first body 110 and the second body 120 are rotated in a direction in which the bodies come closer and the portable terminal is closed, as described above, the first levers 20 and the swing plates 40 are rotated by 100 degrees, and the slide levers 50 and the slide blocks 60 are rotated by 90 degrees. Hence, the first body 110 and the second body 120 coupled to the slide blocks 60 are also rotated by 90 degrees.

As a result, as shown in FIG. 11, the swing plates 40 are rotated to form the central part, that is, the folding part, of the flexible display 140 into the waterdrop shape having a narrow top and a wide bottom.

The waterdrop-type hinge module for a foldable portable terminal and a foldable portable terminal using the same that are the present invention are not limited to the embodiments described above and can be variously modified within the scope of the technical idea of the present invention.

### INDUSTRIAL APPLICABILITY

The present invention can be applied to a hinge module for a portable terminal, thus having industrial applicability.

1. A waterdrop-type hinge module for a foldable portable terminal, comprising: a base body;
a pair of first levers that are disposed separately from each other on both sides of the base body, each having one end coupled to the base body to be rotatable in a vertical direction;
a lever link that connects the pair of first levers separated from each other to synchronize rotational motion of the pair of first levers;
swing plates that are fixedly coupled to the other ends of the first levers and form a folding part of a flexible display mounted on the portable terminal into a waterdrop shape having a narrow top and a wide bottom when the portable terminal is closed;
slide levers having one ends coupled to the base body to be rotatable in the vertical direction; and
slide blocks that have respective upper ends which are rotatably hinge-coupled to the swing plates and respective lower ends to which the slide levers are slidably coupled,
wherein, when the portable terminal is closed,
one of the first levers and one of the swing plates are rotated together, and
the slide blocks are pulled out from the slide levers and slide while being rotated together with the swing plates, and the slide levers are rotated with respect to the base body by the rotation of the slide blocks.

2. The waterdrop-type hinge module for a foldable portable terminal according to claim 1,
wherein, when the portable terminal is closed,
one of the first levers and one of the swing plates are rotated beyond 90 degrees from a horizontal state, and
the slide levers and slide blocks are rotated at an angle smaller than that of the first levers and the swing plates, as the slide levers are in contact with respective stop bumps formed on the base body and stop rotating.

3. The waterdrop-type hinge module for a foldable portable terminal according to claim 2,
wherein outer circumferential surfaces of the one ends of the first levers have respective cam grooves which are obliquely formed,
both ends of the lever link are disposed to be inserted into the cam grooves of the first levers which are disposed on both sides, and
the pair of first levers are rotated in a direction in which the first levers come closer to each other or move away from each other as one of the first levers is rotated and then the other first lever is also synchronized to rotate by the cam groove and the lever link.

4. The waterdrop-type hinge module for a foldable portable terminal according to claim 3,
wherein the one ends of the first levers are formed in a semicircular shape, and
the cam grooves are formed along the respective outer circumferential surfaces of the one ends of the first levers which are formed in the semicircular shape.

5. The waterdrop-type hinge module for a foldable portable terminal according to claim 3,
wherein, when the pair of first levers are horizontally unfolded in opposite directions, the cam grooves formed in the pair of first levers are obliquely formed in the same direction,
the lever link is disposed to be rotatable from the base body in a horizontal direction around a vertical axis of the base body, and
the pair of first levers are synchronized to rotate by horizontal rotation of the lever link.

6. The waterdrop-type hinge module for a foldable portable terminal according to claim 2,
wherein the base body includes an upper body and a lower body which are layered on each other to be coupled,
the one ends of the first levers and one ends of the lever link and the slide lever are inserted and arranged between the upper body and the lower body,
the first levers have respective insertion grooves, and
the lower body has insertion protrusions formed to be inserted into the insertion grooves, respectively, when the first levers are unfolded in the horizontal direction.

7. The waterdrop-type hinge module for a foldable portable terminal according to claim 2,
wherein a first rotation center point of one end of the first levers is located above a second rotation center point of one end of the slide levers, and
the second rotation center point of the one end of the slide lever is located farther away from a central part of the base body than the first rotation center point of the one end of each of the first levers is.

8. The waterdrop-type hinge module for a foldable portable terminal according to claim 2, further comprising:
second levers that have one ends which are coupled to the base body to be rotatable in the vertical direction and the other ends fixedly coupled to the swing plates; and
a contact member that is disposed on the base body and is in contact with outer circumferential surfaces of the one ends of the second levers,
wherein the contact member applies friction to the outer circumferential surfaces of the one ends of the second levers so that the second levers maintain a stop state at a certain angle when the second levers are rotated.

9. The waterdrop-type hinge module for a foldable portable terminal according to claim 8,
wherein the second levers form a pair and are disposed to be separated from each other on both sides of the base body, and
both ends of the contact member inserted into the base body are in contact respectively with the one ends of the pair of second levers, the second levers being disposed to be separated from each other.

10. The waterdrop-type hinge module for a foldable portable terminal according to claim 9,
wherein the contact member is formed of a leaf spring having elastic force.

11. The waterdrop-type hinge module for a foldable portable terminal according to claim 10,
wherein the outer circumferential surfaces of the one ends of the second levers have a first stop groove and a second stop groove which are formed to be separated from each other,
both ends of the contact member have respective stop protrusions which are bent to be inserted into the first stop groove or the second stop groove,
when the portable terminal is unfolded in a horizontal direction, one of the stop protrusions is inserted into the first stop groove,
during a process of folding the portable terminal, the stop protrusions are in contact with the outer circumferential surfaces of the one ends of the second levers between the first stop groove and the second stop groove, and
one of the stop protrusions is inserted into the second stop groove when the portable terminal is folded and closed.

12. The waterdrop-type hinge module for a foldable portable terminal according to claim 11,
wherein, when one of the stop protrusions is disposed adjacent to the first stop groove, the stop protrusion is inserted into the first stop groove by the elastic force of the contact member, rotates the second levers, and applies torque in a direction in which the portable terminal is opened, and
when one of the stop protrusions is disposed adjacent to the second stop groove, the stop protrusion is inserted into the second stop groove by the elastic force of the contact member, rotates the second levers, and applies torque in a direction in which the portable terminal is closed.

13. The waterdrop-type hinge module for a foldable portable terminal according to claim 11,
wherein the contact member includes
main elastic members having the respective stop protrusions bent at both ends of the contact member, and
reinforcing members that are layered and coupled to respective central parts of the main elastic members.

14. A foldable portable terminal comprising: a first body; a second body; a hinge module connecting the first body and the second body, and a flexible display,
wherein the hinge module is configured of the hinge module according to claim 1, and
wherein the first body and the second body are fixedly coupled to the respective slide blocks on both sides, the slide blocks constituting the hinge module.
